(19) United States
(12) Patent Application Publication
(10) Pub. No.: US 2024/0384059 A1
(43) Pub. Date: Nov. 21, 2024

(54) AQUEOUS COMPOSITIONS FOR PROTECTIVE COATINGS, PREPARATION OF SAME, APPLICATION THEREOF TO SUBSTRATES AND THE SUBSTRATES THUS COATED

(71) Applicants: UNIVERSITÉ DE LIMOGES, Limoges (FR); CENTRE NATIONAL DE LA RECHERCHE SCIENTIFIQUE, Paris (FR)

(72) Inventors: Sylvie ROSSIGNOL, Rilhac Rancon (FR); Ameni GHARZOUNI, Couzeix (FR)

(73) Assignees: UNIVERSITÉ DE LIMOGES, Limoges (FR); CENTRE NATIONAL DE LA RECHERCHE SCIENTIFIQUE, Paris (FR)

(21) Appl. No.: 18/579,045

(22) PCT Filed: Jul. 20, 2022
(86) PCT No.: PCT/IB2022/056697

§ 371 Date: Jan. 12, 2024

(30) Foreign Application Priority Data
Jul. 22, 2021 (FR) FR2107955

(51) Int. Cl. C08K 3/34; B05D 1/18; C08J 3/03; C08K 3/22

(52) U.S. Cl. CPC C08K 3/34; B05D 1/18; C08J 3/03; C08K 3/22; C08J 2383/06; C08K 2003/2203

(57) ABSTRACT

An aqueous composition includes, as a mixture: (A) 84 to 99 parts by weight of an aqueous solution of at least one alkali metal silicate (A1) and/or of a solution prepared by dissolving amorphous silica in an aqueous solution of at least one alkali metal hydroxide (A2); (B) 0 to 11 parts by weight of at least one alkali metal hydroxide; and (C) 1 to 5 parts by weight of at least one of the polydimethyl siloxanes of the formula [Chem. 3].

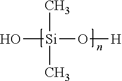

where n is a number from 90 to 410, silicone oils and fluorosilanes, per 100 parts by weight of (A)+(B)+(C), the Si/M molar ratio of the composition being between 0.5 and 2.5, where Si is the silicon of the silicate(s) of the solution (A1) and/or (A2) and M represents the alkali metal(s) of both the silicate(s) of (A1) and/or (A2) and the alkali hydroxide of (B).

The present invention relates to aqueous compositions for the formation of essentially mineral hydrophobic coatings to be applied to substrates to form a protective barrier on the latter against external attacks, e.g. against moisture which may cause water infiltration or corrosion, against weathering which may cause erosion of the substrate surface e.g. by water run-off, against microbial attack, etc.

By “hydrophobic” we mean not only resistance to water, but also the absence of affinity with water: water must not be able to remain on the surface of the substrate receiving the coating. A wetting angle greater 90° than is advantageously targeted.

The substrates concerned are all those used in the fields of construction, building, housing, protection of nuclear drums and packages, anti-fouling surfaces, microwave applications, etc.

To protect these materials, organic hydrophobic coatings are currently used, which emit volatile organic compounds (VOCs) that are hazardous to health and to the environment, and which can not withstand extreme conditions such as frost and UV radiation.

The applicant has sought to solve these problems, and to this end is proposing a solution that represents a technological breakthrough with organic hydrophobic coatings, by considering the production of a hydrophobic, robust, freeze-thaw-resistant mineral coating, that emits no VOCs, requires no energy input to produce, has a low thickness and is transparent or translucent in the visible, enabling the color of the substrate to be retained.

Korean patent application KR 20200097193 A describes an inorganic coating composition comprising an aqueous alkali solution, distilled water and metal silicate trimethoxysilane or triethoxysilane. The result is a water-resistant but non-hydrophobic coating, with wetting angles well below 90°.

US patent application US 2002/0168477 A1 describes an aqueous coating composition comprising lithium polysilicate, sodium or potassium silicate, lithium hydroxide and polyester-modified polydimethyl siloxane surfactant. This composition has not proved hydrophobic in the sense of the invention.

The first object of the present invention is therefore an aqueous composition intended to be applied to a substrate in order to form thereon a protective barrier coating against external attacks, characterized in that it comprises, as a mixture:
(A) 84 to 99 parts by weight of an aqueous solution of at least one alkali metal silicate (A1) and/or of a solution prepared by dissolving amorphous silica in an aqueous solution of at least one alkali metal hydroxide (A2);
(B) 0 to 11 parts by weight of at least one alkali metal hydroxide; and
(C) 1 to 5 parts by weight of at least one from the polydimethylsiloxanes of formula:

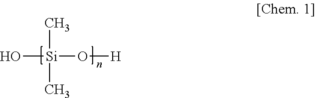

wherein n is a number from 90 to 410, silicone oils and fluorosilanes,
   per 100 parts by weight of (A)+(B)+(C), the Si/M molar ratio of the composition being between 0.5 and 2.5, wherein, in this ratio, Si is the silicon of the silicate(s) of solution (A1) and/or (A2) and M represents the alkali metal(s) of both the silicate(s) of (A1) and/or (A2) and the alkali hydroxide of (B).

In particular, the Si/M molar ratio of the composition can advantageously be comprised between 0.5 and 2.5.

The alkali metal silicate of the solution (A1) can be selected from lithium, sodium or potassium silicates.

The alkali metal hydroxide used in the preparation of the solution (A2) or for the component (B) can be selected in each case independently from lithium, sodium or potassium hydroxides.

The aqueous alkali metal silicate solution (A1) can be 10-50% by weight silicate, particularly 20-45% by weight silicate.

For the preparation of solution (A2), the percentage of silica can vary between 16 and 20% by weight, the percentage of alkali metal hydroxide can vary between 22 and 36% by weight and the percentage of water can vary between 47 and 58% by weight, for 100% by weight of solution (A2), the Si/M ratio of (A2) being in particular from 0.5 to 1, especially 0.7.

Fluorosilanes can be selected from fluoroalkylsilanes and 1H,1H,2H,2H-perfluorooctyltriethoxysilane and 1H,1H,2H,2H-perfluorodecyltriethoxysilane.

When the solution (A1) is a lithium silicate solution, the Si/M ratio can be from 1 to 2.4, in particular from 1 to 1.5.

When the solution (A1) is a potassium silicate solution, the Si/M ratio can be from 0.5 to 1.7, in particular from 0.5 to 1.

When the solution (A1) is a sodium silicate solution, the Si/M ratio can be from 1 to 1.7, in particular 1.

The pH of the composition according to the invention is advantageously between 11 and 14.

The composition obtained according to the invention is advantageously homogeneous for its application.

Another object of the present invention is a method for the preparation of an aqueous composition, characterized in that at least one of the components (C) is mixed with an aqueous solution of at least one alkali metal silicate (A1) and/or a solution prepared by dissolving amorphous silica in an aqueous solution of at least one alkali metal hydroxide (A2), optionally after dissolving therein pellets of at least one alkali metal hydroxide (B).

Another object of the present invention is the application of a composition as defined above, or prepared by a method as defined above, to a substrate selected from geopolymers, concrete, gypsum, limestone, wood, bricks, ceramics and metals, this application being carried out by spraying the composition onto the substrate, by brush-applying the composition onto the substrate, or by dipping the substrate in the composition, followed by drying, in particular air-drying, the composition thus applied.

The invention also relates to a substrate coated by application of the composition as defined above.

The following Examples illustrate the present invention without, however, limiting its scope.

In these Examples, the polysiloxane used is a dihydroxy polydimethyl siloxane with a viscosity of 100 mPa·s⁻¹ at 25° C., marketed under the polymer name OH0.1 by Evonik Operations GmbH (Germany).

### Measurement of the Surface Tension of the Aqueous Compositions Obtained

The instrument used is GBX's Digidrop MCAT. The principle is based on the analysis of a hanging liquid drop. The volume of the drop used is 2 μL.

### Measurement of the Wetting Angle of a Substrate Coated According to the Invention

The instrument used is GBX's Digidrop MCAT. The angle of wetting by a drop of distilled water is measured using Visiodrop software on the various coated substrates.

To this end, a drop of water is deposited on the coated substrate and the angle is measured at t=0s (first image where the drop is deposited on the substrate).

### Measurement of the Freeze-Thaw Resistance

The protocol used for the freeze-thaw tests was as follows:

Each substrate sample underwent 15 freeze-thaw cycles in a climatic chamber. Each cycle, defined in accordance with standard NF EN 14 617-N, comprised:
a steady drop in temperature from +20° C. to −20° C. within 2 hours;
a 4-hour plateau at −20° C. with 0% relative humidity in air;
a steady rise in temperature from −20° C. to +20° C. within 2 hours; and
a 4-hour plateau at +20° C. with 50% relative humidity in air.

For each coated substrate, the wetting angle was measured before and after these 15 freeze-thaw cycles in order to test the substrate's freeze-thaw resistance.

### Measurement of the Resistance to UV Radiation

A coated sample is exposed to UV radiation (A=365 nm) for 2 cycles of 7 h. The wetting angle is measured before and after radiation.

### Determination of Coating Thickness on Geopolymer Sheets

The thickness of coatings formed on geopolymer sample plates was determined by TOF-SIMS analysis.

### Designation of Geopolymer Substrates

Geopolymers are generally prepared from a reactive aluminosilicate source, ideally treated kaolins or activated clays, then activated in an aqueous alkaline medium (soda or potash and alkali silicate). Solid matrices are then obtained by alkali silicate polycondensation reactions.

The following nomenclature is used here to designate geopolymers: S_{M}MxMy (A or S) with:
S_{M}: alkali silicate solution, where M is the alkali cation;
M: K or Na;
M: alkali hydroxide added, if necessary, to adjust the Si/M molar ratio with M=K or Na or Li;
X: molar ratio Si/M of the activation solution, Si from the silicate solution and M from the silicate solution and the added alkali hydroxide;
My: metakaolin used with y=1 or 5 (M1 with Si/Al=1.17 and M5 with Si/Al=1.45);
A or S: added sand, where A stands for granite-durite sand and S for limestone sand.

### Examples 1 to 7: Preparation of Aqueous Lithium Silicate Coating Compositions

### Example 1

In 31.2 g of a 22.2% by weight aqueous solution of lithium silicate (with a Si/Li molar ratio of 2.4), 1.56 g of polysiloxane was added to obtain a mixture.

The resulting mixture was brushed onto the surface of a substrate plate and allowed to dry for at least 1 hour before proceeding with the measurements indicated above.

### Example 2

In 31.2 g of the aqueous starting solution from Example 1, 1.06 g of NaOH pellets were dissolved using a magnetic stirrer for 5 minutes in order to set the Si/M molar ratio (where M=Na+Li) at 1.5.

Next, 1.57 g of polysiloxane was added to obtain a mixture which was processed as described in Example 1.

### Examples 3 to 7

We proceeded as in Example 2, modifying the nature of the alkali hydroxide and/or the quantities added to prepare aqueous coating compositions whose constituent proportions, Si/M molar ratios, surface tension and wetting angle on the coated geopolymer substrate S_{K}K0.58M5 are shown in Table 1 along with those of Examples 1 and 2.

TABLE 1

| | Lithium | Alkali | | | | |
|---|---|---|---|---|---|---|
| | silicate | hydroxide | Poly- | | Surface | Wetting |
| | solution | (%) | siloxane | | tension | angle |
| Example | (%) | (nature) | (%) | Si/M* | (mM/m) | (°) |
| 1 | 95.2 | — | 4.8 | 2.4 | 45 | 85 |
| 2 | 92.1 | 3.1 | 4.8 | 1.5 | 39 | 142 |
| | | (NaOH) | | | | |
| 3 | 94.6 | 0.6 | 4.8 | 2.0 | 40 | 116 |
| | | (LiOH) | | | | |
| 4 | 93.4 | 1.9 | 4.8 | 1.5 | 44 | 100 |
| | | (LiOH) | | | | |
| 5 | 90.9 | 4.4 | 4.8 | 1.0 | 32 | 136 |
| | | (LiOH) | | | | |
| 6 | 88.3 | 7.0 | 4.8 | 1.0 | 28 | 118 |
| | | (NaOH) | | | | |
| 7 | 84.6 | 10.6 | 4.8 | 1.0 | 33 | 114 |
| | | (KOH) | | | | |

*M is the alkali metal derived from both lithium silicate and alkali hydroxide.

### Examples 8 to 13: Preparation of Aqueous Potassium Silicate Coating Compositions

### Example 8

To 30 g of a 20.7% by weight aqueous solution of potassium silicate (with a Si/K molar ratio of 1.7), 1.5 g of polysiloxane was added to obtain a mixture.

The resulting mixture was brushed onto the surface of a substrate plate and allowed to dry for at least 1 hour before proceeding with the measurements indicated above.

### Examples 9 to 13

We proceeded as in Example 9, modifying the nature of the alkali hydroxide and/or the quantities added to prepare aqueous coating compositions whose constituent proportions, Si/M molar ratios, surface tension and wetting angle on the coated geopolymer substrate S_{K}K0.58M5 are shown in Table 2 along with those of Examples 8 and 9.

TABLE 2

| | Potassium | Alkali | | | | |
|---|---|---|---|---|---|---|
| | silicate | hydroxide | Poly- | | Surface | Wetting |
| | solution | (%) | siloxane | | tension | angle |
| Example | (%) | (nature) | (%) | Si/M* | (mM/m) | (°) |
| 8 | 95.2 | — | 4.8 | 1.7 | 66 | 123 |
| 9 | 93.8 | 1.4 (KOH) | 4.8 | 1.5 | 53 | 123 |
| 10 | 89.3 | 6.0 | 4.8 | 1.0 | 52 | 133 |
| | | (NaOH) | | | | |
| 11 | 91.6 | 3.7 | 4.8 | 1.0 | 52 | 124 |
| | | (NaOH) | | | | |
| 12 | 95.2 | — | 4.8 | 0.7 | 87 | 114 |
| 13 | 87.0 | 8.2 (KOH) | 4.8 | 0.5 | 66 | 129 |

*M is the alkali metal derived from both potassium silicate and alkali hydroxide.

### Examples 14 to 17: Preparation of Aqueous Sodium Silicate Coating Compositions

### Example 14

To 30 g of a 35.8% by weight aqueous solution of sodium silicate (with a Si/Na molar ratio of 1.7), 1.5 g of polysiloxane was added to obtain a mixture.

The resulting mixture was brushed onto the surface of a substrate plate and allowed to dry for at least 1 hour before proceeding with the measurements indicated above.

### Example 15

In 30 g of the aqueous starting solution from Example 15, 2.4 g of NaOH pellets were dissolved using a magnetic stirrer for 5 minutes in order to set the Si/Na molar ratio at 1.

Next, 1.60 g of the polysiloxane was added to obtain a mixture which was processed as described in Example 14.

### Examples 16 and 17

We proceeded as in Example 15, modifying the nature of the alkali hydroxide and/or the quantities added to prepare aqueous coating compositions whose proportions of constituents, Si/M molar ratios, surface tension and wetting angle on the coated geopolymer substrate S_{K}K0. 58M5 are shown in Table 3 along with those of Examples 14 and 15.

TABLE 3

| | Sodium | Alkali | | | | |
|---|---|---|---|---|---|---|
| | silicate | hydroxide | Poly- | | Surface | Wetting |
| | solution | (%) | siloxane | | tension | angle |
| Example | (%) | (nature) | (%) | Si/M* | (mM/m) | (°) |
| 14 | 95.2 | — | 4.8 | 1.7 | 61 | 87 |
| 15 | 88.2 | 7.1 | 4.8 | 1.0 | 79 | 129 |
| | | (NaOH) | | | | |
| 16 | 93.8 | 1.4 | 4.8 | 1.5 | 65 | 89 |
| | | (NaOH) | | | | |
| 17 | 84.8 | 10.5 | 4.8 | 1.0 | 52 | 128 |
| | | (KOH) | | | | |

*M is the alkali metal from both sodium silicate and alkali hydroxide

### Example 18: Preparation of an Aqueous Coating Composition Based on a Solution (A2)

A solution (A2) was obtained by dissolving 3.59 g of amorphous silica in a solution of 5.53 g KOH and 10.31 g water. A further 0.9 g of polysiloxane was added.

The resulting mixture was brushed onto the surface of an S_{K}K0.58M5 geopolymer substrate plate and allowed to dry for at least one hour before the above measurements were carried out.

The results are reported in Table 4.

TABLE 4

| | | Alkali | Amor- | | | | |
|---|---|---|---|---|---|---|---|
| | | hydrox- | phous | Polysi- | | Surface | Wetting |
| Exam- | Water | ide (%) | silica | loxane | | tension | angle |
| ple | (%) | (nature) | (%) | (%) | Si/M | (mN/m) | (°) |
| 19 | 50.7 | 27.2 | 17.7 | 4.4 | 0.7 | 49 | 106 |
| | | (KOH) | | | | | |

### Example 19

The wetting angles by a drop of water of plates of different substrates coated with the composition of Example 2 are reported in Table 5.

TABLE 5

| | | | Wetting angle |
|---|---|---|---|
| Substrate | | | (°) |
| Geopolymer | S_{K}K0.58M5 | 2 × 4 × 0.5 cm | 142 ± 1 |
| | | plate | |
| | S_{Na}Na0.7M5 | 2 × 4 × 0.5 cm | 138 ± 3 |
| | | plate | |
| | S_{K}Li0.6M5 | 2 × 4 × 0.5 cm | 129 ± 2 |
| | | plate | |
| | S_{K}K0.58M5 | 6 × 8 × 3 cm plate | 105 ± 4 |
| | S_{Na}Na0.7M5 | 6 × 8 × 3 cm plate | 85 ± 1 |
| | S_{K}Li0.6M5 | 6 × 8 × 3 cm plate | 102 ± 2 |
| | S_{K}K0.58M5 | before 15 | 106 ± 6 |
| | | freeze-thaw | |
| | | cycles | |
| | S_{K}K0.58M5 | after 15 | 97 ± 5 |
| | | freeze-thaw | |
| | | cycles | |
| | S_{K}K0.58M5 GD | before 15 | 104 ± 2 |
| | | freeze-thaw | |
| | | cycles | |
| | S_{K}K0.58M5 GD | after 15 | 95 ± 9 |
| | | freeze-thaw | |
| | | cycles | |
| | S_{K}K0.58M5 S | before 15 | 106 ± 7 |
| | | freeze-thaw | |
| | | cycles | |
| | S_{K}K0.58M5 S | after 15 | 99 ± 4 |
| | | freeze-thaw | |
| | | cycles | |
| | S_{K}0.7M1 | before 15 | 93 ± 4 |
| | | freeze-thaw | |
| | | cycles | |
| | S_{K}0.7M1 | after 15 | 98 ± 4 |
| | | freeze-thaw | |
| | | cycles | |
| | S_{K}0.7M1GD | before 15 | 93 ± 4 |
| | | freeze-thaw | |
| | | cycles | |
| | S_{K}0.7M1GD | after 15 | 84 ± 9 |
| | | freeze-thaw | |
| | | cycles | |
| | S_{K}K0.58M1 | before 15 | 96 ± 7 |
| | | freeze-thaw | |
| | | cycles | |
| | S_{K}K0.58M1 | after 15 | 94 ± 7 |
| | | freeze-thaw | |
| | | cycles | |
| | S_{K}K0.58M1GD | before 15 | 106 ± 2 |
| | | freeze-thaw | |
| | | cycles | |
| | S_{K}0.58M1GD | after 15 | 92 ± 2 |
| | | freeze-thaw | |
| | | cycles | |
| | S_{K}0.7M1GD | after 7 hours | 117 ± 6 |
| | | of exposure | |
| | | to UV | |
| | | radiation | |
| | S_{K}0.7M1GD | after 14 | 120 ± 4 |
| | | hours of | |
| | | exposure to | |
| | | UV radiation | |

| | |
|---|---|
| Gypsum | 99 ± 2 |
| Concrete | 96 ± 3 |
| Blue limestone | 95 ± 2 |
| White limestone | 94 ± 3 |
| Brick | 111 ± 4 |
| Wood | 85 ± 3 |

### Example 20

In order to determine the thickness of coatings formed from aqueous compositions according to the invention, this thickness was investigated on a 2×4×0.5 cm sample plate of S_{K}K0.58M5 geopolymer coated with the composition of Example 2, by the method indicated above. The diffusion of the lithium element over a thickness of around 800 μm was demonstrated on both sides of the sample plate.

### Example 21

In order to study the ageing of aqueous compositions according to the invention, the wetting angle values of coatings formed from the compositions of Examples 2 and 5 on a substrate of the S_{K}K0.58M5 geopolymer were compared at 0 days and then at 11 days. Similar wetting angle values were obtained (approx. 134°).

### Example 22

In 31.2 g of the aqueous starting solution from Example 1, 1.06 g of NaOH pellets were dissolved using a magnetic stirrer for 5 minutes in order to set the Si/M molar ratio (with M=Na+Li) at 1.5. Next, 1.57 g of the fluorosilane: 1H,1H,2H,2H-perfluorodecyltriethoxysilane (PFDTES) was added to obtain a mixture which was processed as indicated in Example 1.

The resulting mixture was brushed onto the surface of a S_{K}K0.58M5 geopolymer substrate plate and allowed to dry for at least 1 hour before surface tension and wetting angle measurements were taken.

The results are shown in Table 6 below:

TABLE 6

| | Lithium | Alkali | | | | |
|---|---|---|---|---|---|---|
| | silicate | hydroxide | Fluoro- | | Surface | Wetting |
| | solution | (%) | silane | | tension | angle |
| Example | (%) | (nature) | (%) | Si/M* | (mM/m) | (°) |
| | 92.2 | 3.1 | 4.6 | 1.5 | 50 | 127 |
| | | (NaOH) | | | | |

1. An aqueous composition intended to be applied to a substrate in order to form thereon a protective barrier coating against external attacks, the aqueous composition comprising, as a mixture:
(A) 84 to 99 parts by weight of at least one of an aqueous solution of at least one alkali metal silicate (A1) and a solution prepared by dissolving amorphous silica in an aqueous solution of at least one alkali metal hydroxide (A2);
(B) 0 to 11 parts by weight of at least one alkali metal hydroxide; and
(C) 1 to 5 parts by weight of at least one of the polydimethylsiloxanes of formula: 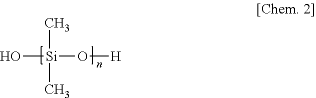
in which n is a number from 90 to 410, silicone oils and fluorosilanes, per 100 parts by weight of (A)+(B)+(C), the Si/M molar ratio of the composition being between 0.5 and 2.5, where, in this ratio, Si is the silicon of the silicate(s) of at least one of (A1) and (A2) and M represents the alkali metal(s) of both the silicate(s) of at least one of (A1) and (A2) and the alkali hydroxide of (B).

2. The composition according to claim 1, wherein the alkali metal silicate of the solution (A1) is selected from lithium, sodium and potassium silicates.

3. The composition according to claim 1, wherein the alkali metal hydroxide used in the preparation of the solution (A2) or for the component (B) is selected in each case independently from lithium, sodium or potassium hydroxides.

4. The composition according to claim 1, wherein the alkali metal silicate solution (A1) is 10 to 50% by weight silicate.

5. The composition according to claim 1, wherein for the preparation of solution (A2), the percentage of silica varies between 16 and 20% by weight, the percentage of alkali metal hydroxide varies between 22 and 36% by weight and the percentage of water varies between 47 and 58% by weight, for 100% by weight of the solution (A2).

6. The composition according to claim 1, wherein the fluorosilanes are selected from fluoroalkylsilanes and 1H,1H,2H,2H-perfluorooctyltriethoxysilane and 1H,1H,2H,2H-perfluorodecyltriethoxysilane.

7. The composition according to claim 1, in which the solution (A1) is a lithium silicate solution, wherein the Si/M ratio is from 1 to 2.4.

8. The composition according to claim 1, in which the solution (A1) is a potassium silicate solution, wherein the Si/M ratio is from 0.5 to 1.7.

9. The composition according to claim 1, in which the solution (A1) is a sodium silicate solution, wherein the Si/M ratio is from 1 to 1.7.

10. The composition according to claim 1, wherein the pH of the composition is between 11 and 14.

11. A method for the preparation of an aqueous composition as defined in to claim 1, wherein at least one of the components (C) is mixed with at least one of an aqueous solution of at least one alkali metal silicate (A1) and a solution prepared by dissolving amorphous silica in an aqueous solution of at least one alkali metal hydroxide (A2), optionally after dissolving therein pellets of at least one alkali metal hydroxide (B).

12. A method for the application of a composition as defined in claim 1 or prepared by a method wherein at least one of the components (C) is mixed with at least one of an aqueous solution of at least one alkali metal silicate (A1) and a solution prepared by dissolving amorphous silica in an aqueous solution of at least one alkali metal hydroxide (A2), optionally after dissolving therein pellets of at least one alkali metal hydroxide (B), to a substrate, the substrate being selected from geopolymers, concrete, gypsum, limestone, wood, bricks, ceramics and metals, wherein the composition is applied by at least one from spraying it onto the substrate, brush-applying it onto the substrate, and by dipping the substrate into the composition, followed by drying the composition thus applied.

13. (canceled)

14. The composition according to claim 4, wherein the alkali metal silicate solution (A1) is 20 to 45% by weight silicate.

15. The composition according to claim 5, wherein the Si/M ratio of (A2) is from 0.5 to 1.

16. The composition according to claim 15, wherein the Si/M ratio of (A2) is 0.7.

17. The composition according to claim 7, wherein the Si/M ratio is from 1 to 1.5.

18. The composition according to claim 8, wherein the Si/M ratio is from 0.5 to 1.

19. The composition according to claim 9, wherein the Si/M ratio is 1.
